(19) United States
(12) Patent Application Publication
(10) Pub. No.: US 2014/0216422 A1
(43) Pub. Date: Aug. 7, 2014

(54) METHOD OF CONTROLLING ENGINE

(71) Applicant: Hyundai Motor Company, Seoul (KR)

(72) Inventors: Jong Il Park, Seoul (KR); Hyun Jun Lim, Incheon (KR); Dong Hee Han, Seoul (KR); Yoon Joo Kim, Yongin-si (KR); Seung Kook Han, Suwon-si (KR)

(73) Assignee: Hyundai Motor Company, Seoul (KR)

(21) Appl. No.: 14/078,046

(22) Filed: Nov. 12, 2013

(30) Foreign Application Priority Data
Feb. 6, 2013 (KR) 10-2013-0013416

(51) Int. Cl. F02M 25/07

(52) U.S. Cl. CPC F02M 25/077
USPC 123/568.11

(57) ABSTRACT

A method of engine control includes: determining and comparing actual and target supply amounts of EGR gas; sensing an open rate of an EGR valve to control the actual supply amount supplied to an intake line; if the actual supply amount is smaller than the target supply amount and if the EGR-valve open rate is at a maximum, fixing an open rate of a bypass valve installed at a bypass line that bypasses an electrodynamic turbocharger to a minimum open rate; and controlling the EGR-valve open rate in a state in which the bypass-valve open rate is fixed to a minimum open rate. Therefore EGR gas can be more precisely and stably supplied.

### CROSS-REFERENCE TO RELATED APPLICATION

The present application claims priority of Korean Patent Application Number 10-2013-0013416 filed Feb. 6, 2013, the entire contents of which application is incorporated herein for all purposes by this reference.

### BACKGROUND OF INVENTION

1. Field of Invention

The present invention relates to a method of controlling an engine that recirculates an exhaust gas (or EGR gas) from an exhaust line to an intake line and that more precisely controls the recirculated EGR gas.

2. Description of Related Art

In general, in most diesel engines and some gasoline engines that are mounted in a vehicle, an exhaust gas recirculation system is installed to correspond to exhaust gas control.

Such an exhaust gas recirculation system drops a combustion temperature of an engine and reduces a generation amount of nitrogen oxide (NOx) by returning a portion of an exhaust gas that is exhausted from the engine to an intake device of a cylinder, thereby reducing fuel consumption.

In a gasoline engine, an electrodynamic turbocharger and an LP-EGR SYSTEM in addition to a mechanical turbocharger are applied, and in order to fully supply an EGR gas, a negative pressure should be formed in a front end portion of the mechanical turbocharger.

Therefore, in order to form a negative pressure in a front end portion of the mechanical turbocharger, by opening an EGR valve that is installed in an EGR line through which an EGR gas passes to the maximum and by controlling a bypass valve of an intake line, a supply amount of an EGR gas can be controlled.

However, because it is difficult to precisely control a supply amount of an EGR gas by adjusting an open rate of the bypass valve, a pressure of a front end portion of the compressor may be irregularly changed.

The information disclosed in this Background section is only for enhancement of understanding of the general background of the invention and should not be taken as an acknowledgement or any form of suggestion that this information forms the prior art already known to a person skilled in the art.

### BRIEF SUMMARY

Various aspects of the present invention provide for a method of controlling an engine having advantages of more stably supplying and precisely controlling an EGR gas by more uniformly maintaining a pressure of a front end portion of a compressor.

Various aspects of the present invention provide for a method of controlling an engine, the method including: sensing or calculating an actual supply amount and a target supply amount of an EGR gas that is supplied from an exhaust line to an intake line and comparing magnitudes thereof; sensing an open rate of an EGR valve that is installed in an EGR line to control an actual supply amount of an EGR gas that is supplied to the intake line; fixing, if the actual supply amount of the EGR gas is smaller than the target supply amount of the EGR gas and if an open rate of the EGR gas is the maximum, an open rate of a bypass valve that is installed at a bypass line that bypasses an electrodynamic turbocharger to a minimum open rate; and controlling an open rate of the EGR valve in a state in which the open rate of the bypass valve is fixed to a minimum open rate.

The electrodynamic turbocharger may be installed at the intake line of the upstream side further than a point that is joined to the EGR line to charge inhaled air and to be operated by a motor.

At the controlling of an open rate of the EGR valve, an open amount of a charging control valve that is disposed at the downstream side of the electrodynamic turbocharger to control an intake flux may be together controlled.

At the exhaust line, a first catalyst unit and a second catalyst unit may be sequentially disposed in an exhaust direction of an exhaust gas, and the EGR line may be branched from the exhaust line between the first catalyst unit and the second catalyst unit.

The engine may further include a mechanical turbocharger that compresses inhaled air of the intake line separately from the electrodynamic turbocharger, wherein the mechanical turbocharger may include a turbine that is disposed at the upperstream side of the first catalyst unit at the exhaust line to rotate by an exhaust gas; and a compressor that is disposed at the downstream side of a point in which the EGR line and the intake line join to rotate by the turbine.

At the downstream side of the compressor, an intercooler that cools the compressed inhaled air and a throttle valve that adjusts a flow amount of inhaled air, having passed the intercooler may be disposed.

As described above, in a method of controlling an engine according to various aspects of the present invention, when an actual supply amount of an EGR gas does not reach a target supply amount, before closing a bypass valve, by fixing the bypass valve to a minimum open rate (step 1) and by simultaneously or selectively adjusting an EGR valve of an EGR line and a charging control valve of the rear end of an electrodynamic turbocharger, an EGR gas can be more precisely and stably supplied.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a schematic diagram of an exemplary engine having an EGR system and a turbocharger according to the present invention.

FIG. 2 is a flowchart illustrating an exemplary method of controlling an engine according to the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

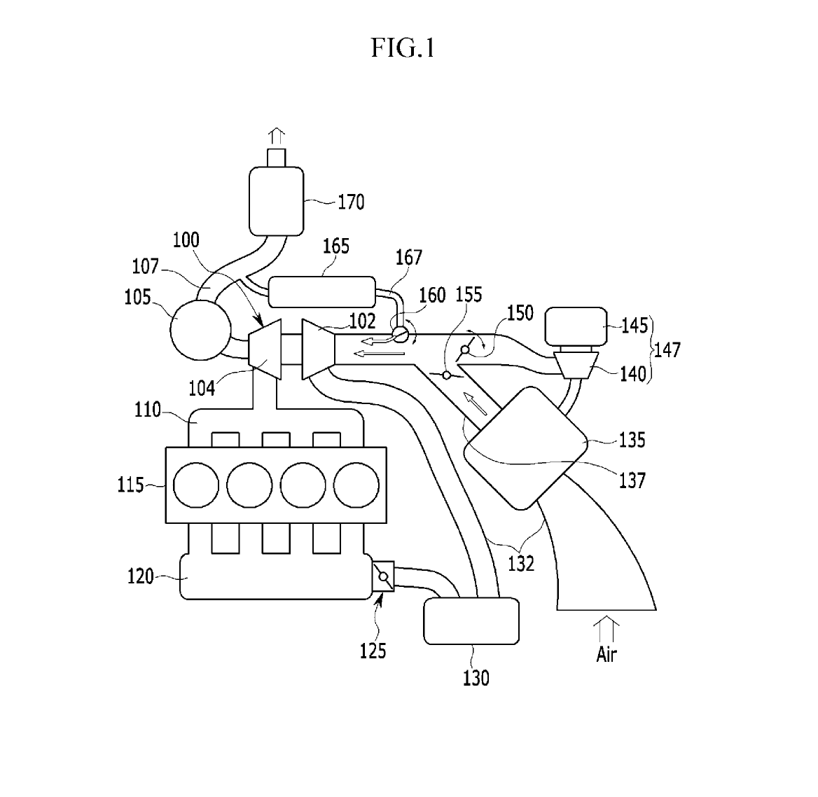

FIG. 1 is a schematic diagram of an engine having an EGR system and a turbocharger according to various embodiments of the present invention.

Referring to FIG. 1, the engine includes an intake line 132, an intake manifold 120, a cylinder block 115, an exhaust manifold 110, and an exhaust line 107.

At the intake line 132, an air cleaner box 135, an electrodynamic turbocharger 147, a charging control valve 155, a compressor 102, an intercooler 130, and a throttle valve 125 are disposed, and a bypass line 137 that bypasses the electrodynamic turbocharger 147 is formed. At the bypass line 137, a bypass valve 150 is disposed.

At the exhaust line 107, a turbine 104, a first catalyst unit 105, and a second catalyst unit 170 are disposed, and an EGR line 167 is formed from the exhaust line 107 to the intake line 132, and at the EGR line 167, a low pressure EGR cooler 165 (or EGR cooler) and a low pressure EGR valve 160 (or EGR valve) are disposed. The EGR line 167 is branched at the downstream side of the first catalyst unit 105 to join at the downstream side of a point in which the intake line 132 and the bypass line 137 join.

An exhaust gas that flows the exhaust line 107 to the mechanical turbocharger 100 rotates the turbine 104, and the compressor 102 compresses inhaled air of the intake line 132 by a torque of the turbine 104 and supplies the inhaled air to a cylinder.

The electrodynamic turbocharger 147 includes an electrodynamic turbine 140 and a motor 145, and the motor 145 has a structure that selectively compresses inhaled air by rotating the electrodynamic turbine 140 according to a driving condition.

The EGR cooler 165 adjusts a flow amount of an EGR gas that flows the EGR line 167, the charging control valve 155 adjusts a flow amount of inhaled air flowing the intake line 132, and the bypass valve 150 adjusts a flow amount of inhaled air flowing the bypass line 137.

In order to increase a quantity of an EGR gas (recirculated gas) that is supplied through the EGR line 167, the bypass valve 150 may be closed.

However, in various embodiments of the present invention, the bypass valve 150 is fixed or adjusted to a minimum open rate that is not completely closed, and in order to achieve an accurate target supply amount of an EGR gas, an open rate of the EGR valve 160 may be controlled. Further, while an open rate of the EGR valve 160 is controlled, an open rate of the charging control valve 155 may be together controlled.

In various embodiments of the present invention, in order to obtain an enough differential pressure for recirculating an EGR gas, a minimum open rate in which the bypass valve 150 is not completely closed may be calculated in a separate control unit (ECU) (not shown) or may be selected from preset data.

In various embodiments of the present invention, a control unit calculates or selects a target supply amount of an EGR gas that is recirculated from the exhaust line 107 to the intake line 132 based on a driving condition, and determines (e.g., calculates or senses) an actual supply amount of an actually recirculated EGR gas. In order to an actual supply amount to follow a target supply amount, the control unit controls the EGR valve 160, the charging control valve 155, and the bypass valve 150. Such a series of control methods are well-known technology and therefore a detailed description thereof will be omitted.

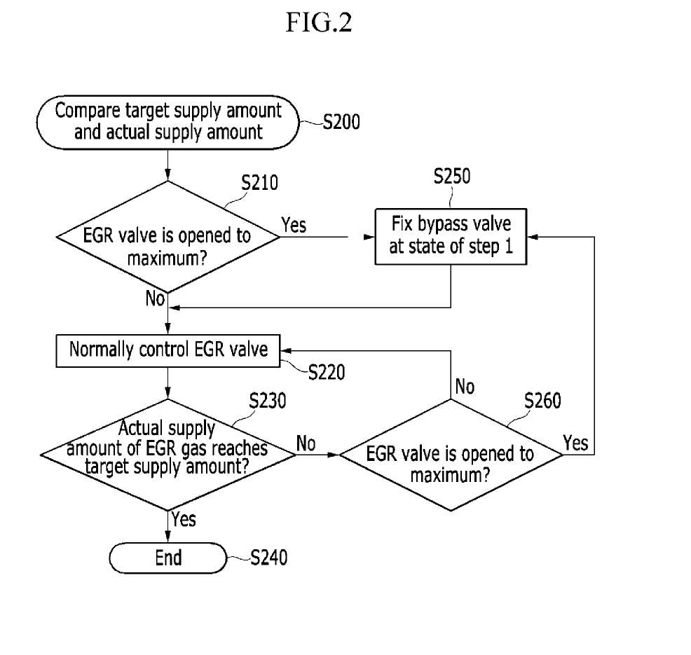

FIG. 2 is a flowchart illustrating a method of controlling an engine according to various embodiments of the present invention.

Referring to FIG. 2, the control unit compares a target supply amount and an actual supply amount of an EGR gas that is supplied through the EGR line 167 (S200). An actual supply amount may be calculated through a flux sensor or a differential pressure sensor, and a target supply amount may be calculated according to a driving condition or may be selected from preset data.

The control unit determines whether the EGR valve 160 is opened to the maximum (S210). If the EGR valve 160 is opened to the maximum, the process continues at step S250, and if the EGR valve 160 is not opened to the maximum, the process continues at step S220.

The EGR valve 160 and the bypass valve 150 are normally controlled (S220), and the bypass valve 150 is fixed at minimum open rate (S250). That is, the bypass valve 150 operates at several steps and is fixed to a state of step 1 before being closed (S250).

The control unit determines whether an actual supply amount of an EGR gas reaches a target supply amount (S230), and if an actual supply amount of an EGR gas reaches a target supply amount, the process continues at step S240, and if an actual supply amount of an EGR gas does not reach a target supply amount, the process continues at step S260.

The control unit determines whether the EGR valve 160 is opened to the maximum (S260). If the EGR valve 160 is opened to the maximum, the process continues at step S250, and if the EGR valve 160 is not opened to the maximum, the process continues at step S220.

In various embodiments of the present invention, even if the EGR valve 160 is completely opened, if an actual supply amount of an EGR gas does not reach a target supply amount, an EGR valve is controlled to inject an EGR gas through a pressure drop of the upstream side of the mechanical turbocharger 100. For this purpose, the bypass valve is controlled to a minimum open rate, and the EGR valve is controlled.

For convenience in explanation and accurate definition in the appended claims, the terms upper, front or rear, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A method of controlling an engine, the method comprising:
determining an actual supply amount and a target supply amount of an EGR gas supplied from an exhaust line to an intake line and comparing magnitudes thereof;
sensing an open rate of an EGR valve installed in an EGR line to control an actual supply amount of an EGR gas supplied to the intake line;
adjusting an open rate of a bypass valve to a minimum open rate if the actual supply amount of the EGR gas is smaller than a target supply amount of the EGR gas and if an open rate of the EGR gas is the maximum, wherein the bypass valve is installed at a bypass line that bypasses an electrodynamic turbocharger; and
controlling an open rate of the EGR valve in a state in which the open rate of the bypass valve is fixed to a minimum open rate.

2. The method of claim 1, wherein the electrodynamic turbocharger is installed in the intake line upstream from the EGR line and operated by a motor to charge inhaled air.

3. The method of claim 1, wherein the controlling of the open rate of the EGR valve further includes controlling an open amount of a charging control valve disposed downstream of the electrodynamic turbocharger to control an intake flux.

4. The method of claim 1, wherein a first catalyst unit and a second catalyst unit are sequentially disposed in an exhaust direction of the exhaust gas, and the EGR line branches from the exhaust line between the first catalyst unit and the second catalyst unit.

5. The method of claim 4, wherein the engine further comprises a mechanical turbocharger that compresses inhaled air of the intake line separately from the electrodynamic turbocharger; and
wherein the mechanical turbocharger comprises a turbine disposed upperstream of the first catalyst unit at the exhaust line to rotate by exhaust gas, and a compressor driven by the turbine and disposed downstream of a point at which the EGR line and the intake line join.

6. The method of claim 5, wherein an intercooler downstream of the compressor cools the compressed inhaled air, and a throttle valve downstream of the intercooler adjusts a flow amount of inhaled air.
